(19) United States
(12) Patent Application Publication
(10) Pub. No.: US 2017/0127112 A1
(43) Pub. Date: May 4, 2017

(54) VEHICLE IMAGE TRANSMISSION SYSTEM

(71) Applicant: MITSUBISHI ELECTRIC CORPORATION, Tokyo (JP)

(72) Inventors: Yasunori HOSHIHARA, Tokyo (JP); Kiyotaka KATO, Tokyo (JP)

(73) Assignee: MITSUBISHI ELECTRIC CORPORATION, Tokyo (JP)

(21) Appl. No.: 15/124,537

(22) PCT Filed: May 23, 2014
(86) PCT No.: PCT/JP2014/063723

§ 371 Date: Sep. 8, 2016

(51) Int. Cl. H04N 21/414; H04N 21/41; H04N 21/431; H04N 21/439; H04N 21/4363; B60K 35/00; H04N 21/44

(52) U.S. Cl. CPC H04N 21/41422; B60K 35/00; H04N 21/4126; H04N 21/44; H04N 21/439; H04N 21/43632; H04N 21/4312; B60K 2350/1028; B60K 2350/106; B60K 2350/307; B60K 2350/352

(57) ABSTRACT

A vehicle image transmission system has AV devices which are capable of connecting mobile data terminals and are connected in a multistage fashion through wire. Each of the AV devices includes a display unit; a communication processing unit to receive a communication signal transmitted across the AV devices, and to superimpose and transmit uncompressed video data of the mobile data terminal connected to the self AV device through wire; and an AV integrated processing unit to cause the display unit to display at least one of the uncompressed video data of the mobile data terminal connected to the self AV device through wire and the uncompressed video data which is of the mobile data terminal connected to another one of the AV devices through wire, and has been superimposed on the communication signal the communication processing unit receives.

### TECHNICAL FIELD

The present invention relates to a vehicle image transmission system including AV (AudioVisual) devices connected in a multistage fashion for displaying video data in a vehicle.

### BACKGROUND ART

Recently, an onboard information device has provided a user with new functions in cooperation with a mobile data terminal like a smartphone or tablet PC (Personal Computer). For example, a device is offered which sends the vehicle information from the onboard information device to the mobile data terminal, sends back various processing results of applications in the mobile data terminal to the onboard information device as video and audio data, and outputs them from the display unit and speaker of the onboard information device.

A Patent Document 1 proposes a system that displays video-data of one or more portable electronic devices on a plurality of display devices on a vehicle side. Here, the control unit of an integrated video system installed in a vehicle is electrically connected to the plurality of display devices, and comprises a wireless receiver. The portable electronic devices each comprise a wireless transmitter to exchange the video data and a control (operation) signal between the wireless transmitter and a wireless receiver connected to the control device of the integrated video system via wireless transmission. More specifically, the portable electronic device wirelessly transmits the video compressed data to the integrated video system; and the control device of the integrated video system expands the video compressed data, executes image processing required, and causes the display devices in the vehicle to display the image processing results.

In a conventional data transmission scheme used in general such as that of the foregoing Patent Document 1, the mobile data terminal executes encoding processing of the video and audio data to perform data compression, and wirelessly transmits them to the onboard information device. Recently, as for the wireless transmission, the wireless communications protocol IEEE 802.11 (WiFi) or Bluetooth (registered trademark) has become the mainstream (see Patent Document 2, for example).

### PRIOR ART DOCUMENT

### Patent Document

Patent Document 1: Japanese Patent Laid-Open No. 2007-186194.

Patent Document 2: Brochure of WO2012/101679

### DISCLOSURE OF THE INVENTION

### Problems to be Solved by the Invention

Although the foregoing Patent Document 1 discloses a configuration capable of connecting a plurality of portable electronic devices, as the number of the portable electronic devices connected increases, it becomes necessary to guarantee the wireless communications capacity required to transmit the video data. However, since the WiFi does not have enough capacity, and radio-frequency interference such as that described in the foregoing Patent Document 2 can occur in the in-vehicle wireless transmission, the conventional system has a problem of causing an image disturbance due to data error during the transmission. Furthermore, as the portable electronic device improves its performance in terms of the image high-definition and high quality and increases its video data volume, the inclination becomes stronger.

In addition, when the plurality of portable electronic devices transmit the video compressed data, and if the integrated video system displays, on the display devices connected to it, the images of the foregoing portable electronic devices freely, the integrated video system need include in the interior thereof image expanders whose number is equal to the number of the portable electronic devices, thereby leading to the enlargement of the system. In addition, to wire the integrated video system to the plurality of display devices, it is necessary to ensure an in-vehicle installation space and cable wiring space, and hence the degree of freedom of the installation and wiring is low.

The present invention is implemented to solve the foregoing problems. Therefore it is an object of the present invention to provide a vehicle image transmission system capable of transmitting high-definition images, reducing the size of the system and improving the degree of freedom of installation and wiring.

### Means for Solving the Problems

A vehicle image transmission system in accordance with the present invention includes a plurality of AV devices which are connectable with mobile data terminals through wire, and are connected in a multistage fashion through wire, each of the AV devices includes a display, a communication processor to receive a communication signal transmitted across the plurality of AV devices connected in the multistage fashion through wire, and to superimpose, on the communication signal, uncompressed video data of the mobile data terminal connected to the self AV device through wire, and to transmit a resultant signal, and an AV integrated processor to cause the display to display at least one of the uncompressed video data of the mobile data terminal connected to the self AV device through wire and uncompressed video data that is of the mobile data terminal connected to another one of the AV devices through wire and that has been superimposed on the communication signal the communication processor receives.

### Advantages of the Invention

According to the present invention, since it connects between the AV devices through wire and transmits the uncompressed video data, it can suppress the AV processing delay, and handle the high-definition images transmitted from another one of the AV devices in real time. In addition, since the AV devices are connected with the mobile data terminals through wire and handle the uncompressed video data, they can obviate the need for codec. Furthermore, since it comprises one AV control device for one display unit, it can reduce the size of the system as compared with a conventional system including the single AV device which expands through its multiple image expanders the plurality of compressed video data to be displayed on the plural display units. This enables increasing the degree of freedom of the installation and wiring of the AV devices.

### BRIEF DESCRIPTION OF THE DRAWINGS

FIG. 1 is a system diagram showing a configuration of a vehicle image transmission system of an embodiment 1 in accordance with the present invention;

FIG. 2 is a diagram showing a structure of data to be transmitted across AV devices of the vehicle image transmission system of the embodiment 1;

FIG. 3 is a block diagram showing a configuration of an AV device of the vehicle image transmission system of the embodiment 1;

FIG. 4 is a diagram showing an image transition example of an AV device of the vehicle image transmission system of the embodiment 1;

FIG. 5 is a diagram showing an example in which any one of the AV devices of the vehicle image transmission system of the embodiment 1 operates the mobile data terminal connected to another one of the AV devices;

FIG. 6 is a block diagram showing a configuration of an AV device of a vehicle image transmission system of an embodiment 2 in accordance with the present invention;

FIG. 7 is a diagram showing an example of a menu window of an AV device of the vehicle image transmission system of the embodiment 2; and

FIG. 8 is a block diagram showing a configuration of an AV device of a vehicle image transmission system of an embodiment 3 in accordance with the present invention.

### BEST MODE FOR CARRYING OUT THE INVENTION

The best mode for carrying out the invention will now be described with reference to accompanying drawings to explain the present invention in more detail.

### Embodiment 1

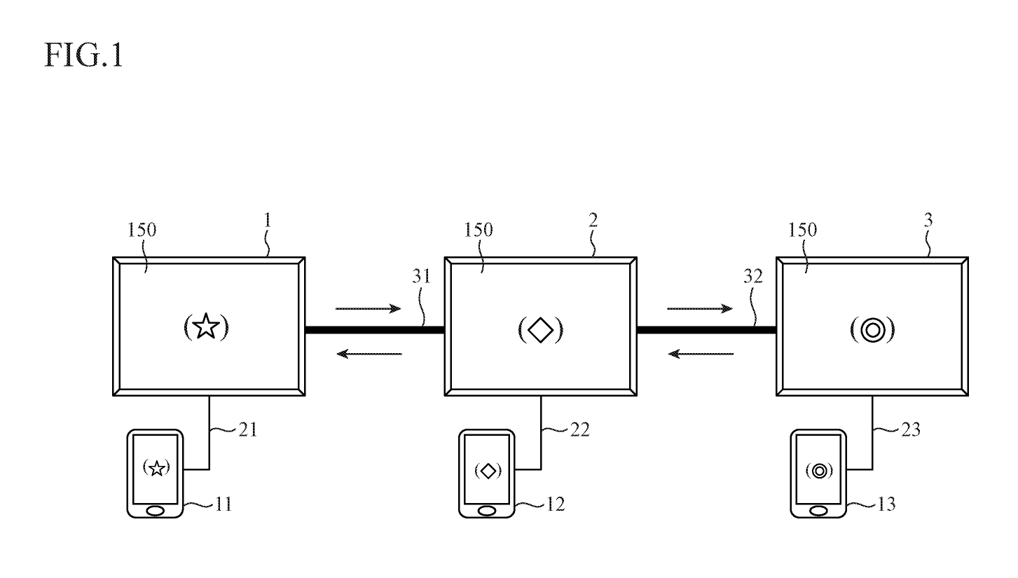

As shown in FIG. 1, a vehicle image transmission system of the embodiment 1 is comprised of a plurality of AV devices. The example shown comprises three AV devices connected in series in a multistage fashion, an AV device 1, an AV device 2, and an AV device 3. When mounting the vehicle image transmission system in a car, the AV device 1 is set on the driver' s seat side of the dashboard, the AV device 2 in front of the left rear seat, and the AV device 3 in front of the right rear seat, for example. Incidentally, the vehicle is not limited to a car, but includes a railway vehicle, a ship, an aircraft and the like.

Each of the AV devices 1-3 comprises a wired interface for receiving video data and audio data (referred to as video/audio data from now on) of mobile data terminals 11-13. The interface is a communication interface that transmits the video/audio data with an uncompressed format, which does not undergo compression by encoding. For example, it can be a digital interface such as an HDMI (registered trademark), or an analog interface. Each of the AV devices 1-3 can reproduce the video/audio data, which is input from one of the mobile data terminals 11-13 via the interface, with the display unit and speaker of its own.

In addition, each of the AV devices 1-3 comprises, besides the wired interface of the video/audio data, an interface that transmits control data for controlling the AV devices 1-3 and mobile data terminals 11-13 with each other.

Incidentally, in the example shown in FIG. 1, the AV device 1 is connected with the mobile data terminal 11 through a cable 21 capable of transmitting the video/audio data and the control data simultaneously. Likewise, the AV device 2 is connected with the mobile data terminal 12 through a cable 22, and the AV device 3 is connected with the mobile data terminal 13 through a cable 23.

Furthermore, each of the AV devices 1-3 comprises a communication interface for electrically connecting them in a multistage fashion. In the example shown in FIG. 1, the AV device 1 is connected with the AV device 2 through a cable 31, and the AV device 2 is connected with the AV device 3 through a cable 32.

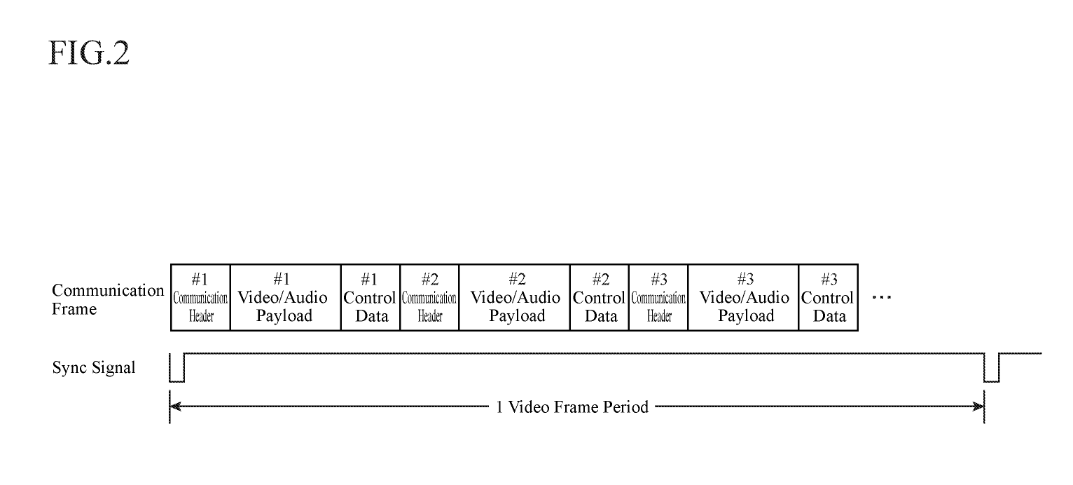

Each of the AV devices 1-3 converts the video/audio data input from the mobile data terminals 11-13 into a designated format (such as RGB888 for video data), superimposes the converted data on a designated communication frame format (communication signal), and transmits it through the communication interface. As for the communication frame format, although its details will be described later with reference to FIG. 2, it is assumed that its data structure supposes high-speed serial communication capable of transmitting one communication frame within one video frame period. This enables each of the AV devices 1-3 to reproduce not only the video/audio data of the mobile data terminal connected to the self device, but also the video/audio data of the mobile data terminal connected to another one of the AV devices in real time with little delay.

Each of the mobile data terminals 11-13 consists of a smartphone or a tablet PC. The example in FIG. 1 shows that the video data of the display screens (star), (diamond) and (double circles) of the applications operating in the individual mobile data terminals 11-13 are also displayed on the display units 150 of the AV devices 1-3 to which the mobile data terminals 11-13 are connected. Assume that the AV devices are connected in a multistage fashion beginning from the AV device 1 followed by the AV devices 2 and 3 in one direction. When the AV device 1 operates as the master apparatus which is powered on first, the communication direction from the AV device 1 toward the AV device 3 is called “downstream” direction, and the opposite communication direction from the AV device 3 toward the AV device 1 is called “upstream.” direction.

FIG. 2 shows the structure of data transmitted across the AV devices 1-3. The master AV device 1 generates a communication frame at a sync signal timing of a video frame, and transmits it to the AV device 2. The AV device 2 extracts the sync signal timing for the video frame from the received communication frame, generates the internal reference clock of the self device by using the timing, and establishes communication between the two devices using the communication frame format specified for the upstream direction, that is, for the AV device 1 in the same manner. Furthermore, the AV device 2 executes the same operation as that performed between the AV device 1 and the AV device 2 to the AV device 3, establishes the communication in both the downstream direction and upstream direction, and maintains the timing sync across the individual AV devices 1-3.

The format of the communication frame is comprised of a communication header, a video/audio payload, and control data. The AV device 1 generates the #1 communication header, #1 video/audio payload, and #1 control data, superimposes them on the communication frame and transmits it. Likewise, the AV devices 2 and 3 generate #2 and #3 communication headers, #2 and #3 video/audio payloads, and #2 and #3 control data, superimpose them on communication frames and transmit them.

The communication header includes a frame type, self device number, valid device number, effective data amount, error-detecting code and the like. The frame type is the information indicating the AV device that generates the frame. The self device number is the information indicating how many devices are connected before the self device in the series beginning from the master AV device. The valid device number is the information indicating the total number of the AV devices connected in the vehicle image transmission system. The error-detecting code is a code (such as a Cyclic Redundancy Check: CRC) added for detecting an error in the communication header.

The video/audio payload is data with a digital format obtained by converting the video/audio data, which is input from the mobile data terminals 11-13 to the AV devices 1-3, into a designated format, and is superimposed on the communication frame using one video frame period as a unit.

The control data is data obtained by sampling at every video frame period the operation information a user inputs through an operation device (such as a touch screen or buttons) each of the AV devices 1-3 comprises. The control data is the data for controlling the operation of the mobile data terminals 11-13 connected to the AV devices 1-3.

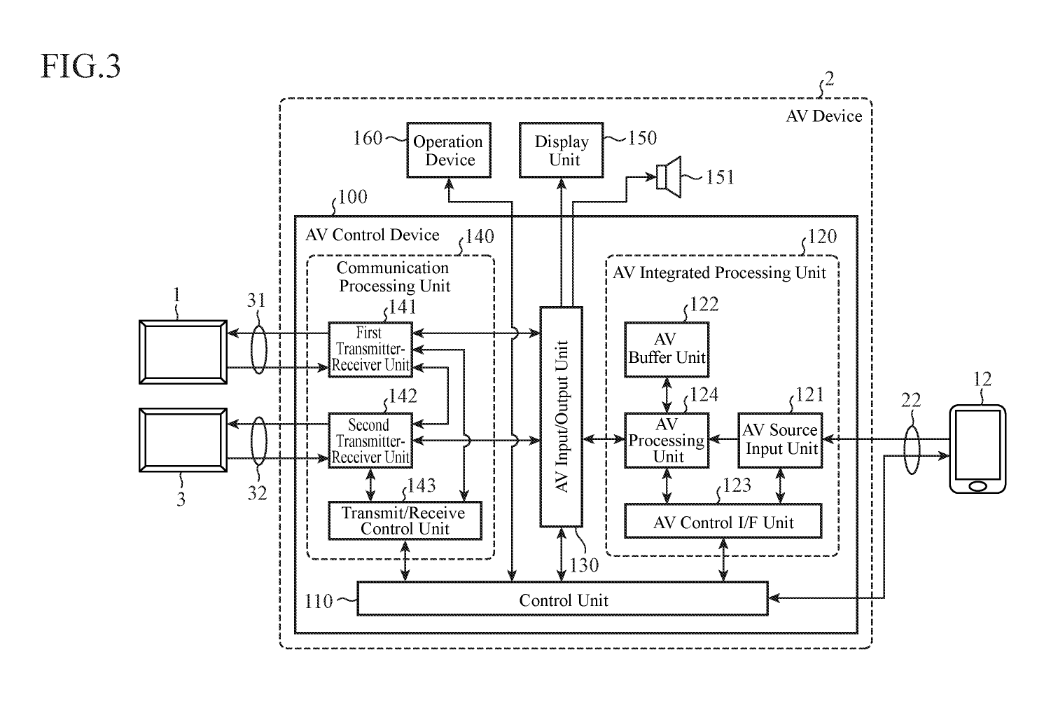

FIG. 3 is a block diagram showing a configuration of the AV device 2. Although FIG. 3 shows the AV device 2 as a representative example, the AV devices 1 and 3 have the same configuration.

The AV device 2 comprises an AV control device 100, a display unit 150, a speaker 151 (or headphones), and an operation device 160. In addition, the mobile data terminal 12 which is a video/audio data source is connected to the AV device 2 through the cable 22. Furthermore, the AV device 2 is connected with the AV device 1 through the cable 31 and with the AV device 3 through the cable 32.

The AV control device 100 comprises a CPU (Central Processing Unit) and various memories not shown, and implements the functions of a control unit 110, an AV integrated processing unit 120, an AV input/output unit 130, and a communication processing unit 140, which will be described below, by means of the CPU that executes programs. Incidentally, part of the AV control device 100 can be implemented by a dedicated circuit.

The control unit 110 carries out the control of the whole or part of the AV device 2. Its contents can be roughly divided into the following items (1)-(5).

### (1) Control of Mobile Data Terminal 12.

The control unit 110 decides whether the mobile data terminal 12 is connected to the self device or not. In addition, the control unit 110 executes the control at a time when it transfers to the other AV devices 1 and 3 the operation information the operation device 160 of the self device outputs or the operation information transferred from the operation device 160 connected to another one of the AV devices 1 and 3 via the cable 31 or 32.

### (2) Control of AV Integration Processing Unit 120.

The control unit 110 instructs the AV integrated processing unit 120 as to which one of the mobile data terminals 11-13 should be chosen as the source of the video data to be displayed on the display unit 150. In addition, the control unit 110 instructs the AV integrated processing unit 120 on the scaling of an image to be displayed on the display unit 150, and on the simultaneous display (image superimposition) of the video data of a plurality of sources. Furthermore, the control unit 110 instructs the AV integrated processing unit 120 on the information about setting a menu window to be displayed on the display unit 150.

### (3) Control of AV Input/Output Unit 130.

The control unit 110 instructs the AV input/output unit 130 to adjust the backlighting of the display unit 150. In addition, the control unit 110 instructs the AV input/output unit 130 to adjust the volume of the speaker 151.

### (4) Control of Communication Processing Unit 140.

The control unit 110 controls the transmit/receive of the communication header and control data of the communication frame, which the communication processing unit 140 performs. In addition, the control unit 110 controls monitoring of a state of the communication the communication processing unit 140 performs with the other AV devices 1 and 3 (monitoring of the presence or absence of data reception and the like, for example).

### (5) Control of Operation Device 160

The control unit 110 acquires the operation information the operation device 160 outputs, and decides the operation contents a user performs on the operation device 160.

The AV integrated processing unit 120 comprises an AV source input unit 121, an AV buffer unit 122, an AV control interface (I/F from now on) 123, and an AV processing unit 124. The AV source input unit 121 receives the video/audio data the mobile data terminal 12 outputs, and stores it temporarily in the AV buffer unit 122 via the AV processing unit 124. At the time, the AV source input unit 121 is also able to convert the video/audio data to a format designated by the system so that it can store the data in the AV buffer unit 122 temporarily. The AV buffer unit 122 stores not only the video/audio data of the mobile data terminal 12 the AV source input unit 121 receives, but also the video/audio data received through the communication processing unit 140 from the mobile data terminals 11 and 13 connected to the other AV devices 1 and 3.

According to the instruction sent from the control unit 110 via the AV control I/F unit 123, the AV processing unit 124 performs the processing such as the selection of the source of the video/audio data stored in the AV buffer unit 122, the scaling of an image, and a simultaneous display (such as image superimposition) of the video data of a plurality of sources, and transmits the video/audio data after the processing to the AV input/output unit 130.

In addition, the AV processing unit 124 has a graphics function, and generates a menu window of the AV device 1 by writing letters and drawing a figure in response to the instruction from the control unit 110. The AV processing unit 124 is able to superimpose the menu window it generates on the foregoing video/audio data passing through the scaling of the image, and to transmit its result to the AV input/output unit 130.

The AV input/output unit 130 outputs the video/audio data which has passed through the processing and is sent from the AV processing unit 124 by adjusting the data to the interface of the display unit 150 and speaker 151 of the self device. At this time, according to the instruction from the control unit 110, the AV input/output unit 130 is able to adjust, as to the image, the luminous intensity of the backlighting and the like of the display unit 150, and as to the sound, the volume of the output of the speaker 151.

In addition, according to the instruction of the control unit 110, the AV input/output unit 130 outputs the video/audio data of the mobile data terminal 12 stored in the AV buffer unit 122 to a first transmitter-receiver unit 141 and a second transmitter-receiver unit 142. The video/audio data becomes the video/audio payload of the self device. In addition, according to the instruction of the control unit 110, the AV input/output unit 130 outputs the video/audio data of another one of the AV devices 1 and 3 the communication processing unit 140 receives to the AV buffer unit 122 via the AV processing unit 124.

The communication processing unit 140 comprises the first transmitter-receiver unit 141, the second transmitter-receiver unit 142, and a transmit/receive control unit 143. The first transmitter-receiver unit 141 and second transmitter-receiver unit 142 are electrically connected to the other AV devices 1 and 3 via the cables 31 and 32 to carry out communication in conformity with the communication frame format shown in FIG. 2.

The transmit/receive control unit 143 recognizes that the self device is the master apparatus and operates as the master apparatus if both the first transmitter-receiver unit 141 and the second transmitter-receiver unit 142 do not receive a signal even if a fixed time has elapsed from a start of the AV device 2. In addition, it sends information that the self device is the master apparatus from the transmit/receive control unit 143 to the control unit 110. On the other hand, when the first transmitter-receiver unit 141 or the second transmitter-receiver unit 142 receives a signal, the transmit/receive control unit 143 extracts the communication header generated by another one of the AV devices 1 and 3 from the received communication frame, and informs the control unit 110 of it. According to the communication header informed, the control unit 110 decides how many devices are connected from the master apparatus to the self device, and sets the communication header of the self device. In addition, the control unit 110 sets the control data in accordance with the operation information sent from the operation device 160.

The communication header and control data of the self device set by the control unit 110 are supplied to the first transmitter-receiver unit 141 and second transmitter-receiver unit 142 via the transmit/receive control unit 143. In addition, the received signal of the first transmitter-receiver unit 141 transmitted from the AV device 1 is transferred as it is as a transmit signal of the second transmitter-receiver unit 142, and is retransmitted from the second transmitter-receiver unit 142 to the AV device 3 together with the foregoing transmit signal (communication header, video/audio payload, control data) of the self device in conformity with the communication frame format of FIG. 2. Likewise, the signal from the AV device 3 received by the second transmitter-receiver unit 142 is processed in the same manner except that the communication direction is opposite to the foregoing, and is retransmitted from the first transmitter-receiver unit 141 to the AV device 1.

Furthermore, the communication header and control data in the signal received by the first transmitter-receiver unit 141 and second transmitter-receiver unit 142 are transferred to the control unit 110 via the transmit/receive control unit 143, and are used by the control unit 110 for controlling the self device. In addition, the video/audio payload in the received signal is stored in the AV buffer unit 122 of the AV integrated processing unit 120 via the AV input /output unit 130, and is used appropriately as the video/audio data to be processed by the AV processing unit 124 according to the instruction of the control unit 110.

The display unit 150 consists of a liquid crystal display or the like integrated into the AV control device 100. As for the speaker 151, it may be a speaker integrated with the AV control device 100, or it may be headphones connected to the AV control device 100 through wire or wireless. The operation device 160 may be a touch screen integrated into the display unit 150 or buttons arranged around the display unit 150.

Next, the operation of the AV device 2 will be described when it outputs the video/audio data of the mobile data terminal connected to any one of the plurality of AV devices 1-3 connected in a multistage fashion. First, the operation relating only to images will be described on the assumption that the video data of the mobile data terminals 11-13 connected to the three AV devices 1-3, respectively, are displayed on the screen as shown in FIG. 1.

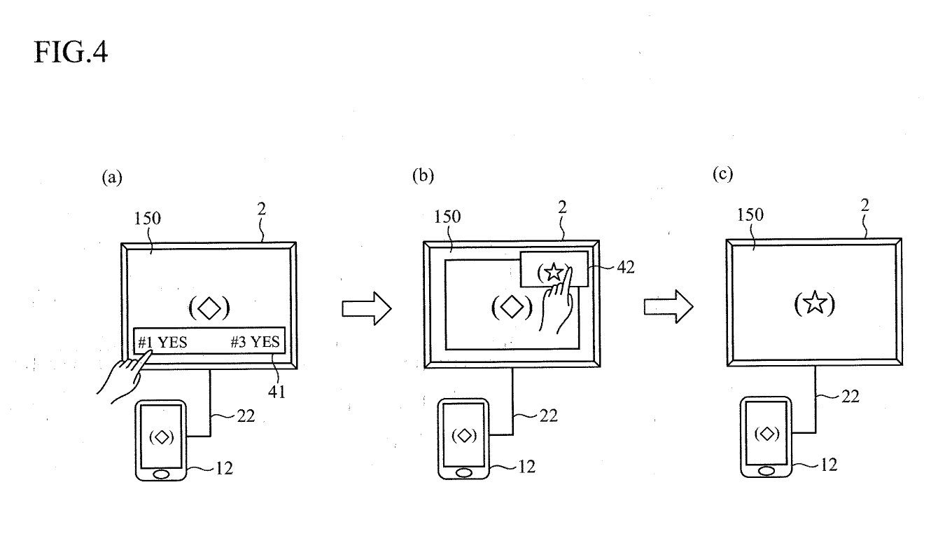

FIG. 4 is an example of an image transition on the AV device 2 in the vehicle image transmission system of the embodiment 1. As for the AV devices 1 and 3 and the mobile data terminals 11 and 13, they are not shown in FIG. 4.

In FIG. 4(a), the AV device 2 displays on its display unit 150 the video data (diamond) on the display screen of the mobile data terminal 12. Furthermore, the AV device 2 superimposedly displays the menu window 41 on the display screen (diamond) of the display unit 150 to inform a user that it has the video data on the display screens (star) and (double circles) of the mobile data terminals 11 and 13 connected to the other AV devices 1 and 3 have. The menu window 41 shows the presence of the mobile data terminal 11 connected to the AV device 1 by “#1 YES”, and the presence of the mobile data terminal 13 connected to the AV device 3 by “#3 YES”.

As for the presence or absence of the video data of the mobile data terminals 11 and 13 connected to the other AV devices 1 and 3, the control unit 110 of the AV device 2 decides it from the contents of the communication header transmitted from the other AV devices 1 and 3. The control unit 110 instructs the AV integrated processing unit 120 to execute the control in such a manner as to display the menu informing that the mobile data terminals 11 and 13 have their video data by using the number (#1, #3) or the like of the mobile data terminals.

In FIG. 4(a), when the user touches the menu window 41 of the AV device 2 through the operation device 160 like a touch screen attached to the display unit 150, a thumbnail image 42 of the video data corresponding to the number of the mobile data terminal touched is superimposedly displayed on the display screen as shown in FIG. 4(b). Here, the AV buffer unit 122 of the AV integrated processing unit 120 stores not only the video data of the display screen (diamond) of the mobile data terminal 12 connected to the self device, but also the video/audio payload of the other AV devices 1 and 3 received by the communication processing unit 140 (that is, the video data of the display screens (star) and (double circles) of the mobile data terminals 11 and 13). When the operation information indicating that the number of the #1 mobile data terminal 11 is touched is sent from the operation device 160 to the control unit 110 of the AV device 2, the control unit 110 instructs the AV integrated processing unit 120 in response to the operation information to superimposedly display the thumbnail image 42, which is obtained by scaling down the #1 display screen (star), on the display screen (diamond) of the self device.

In FIG. 4(b), when the user touches the thumbnail image 42 of the AV device 2, the display screen (diamond) of the display unit 150 is switched to the #1 display screen (star) as shown in FIG. 4(c). Here, the control unit 110 receives the operation information indicating that the thumbnail image 42 is touched from the operation device 160, instructs the AV integrated processing unit 120 to switch the full-screen display of the screen (diamond) of the mobile data terminal 12 connected to the self device to the full-screen display of the screen (star) of the #1 mobile data terminal 11. This enables the display unit 150 of the AV device 2 to display the video data of the mobile data terminal 11 connected to said another AV device 1.

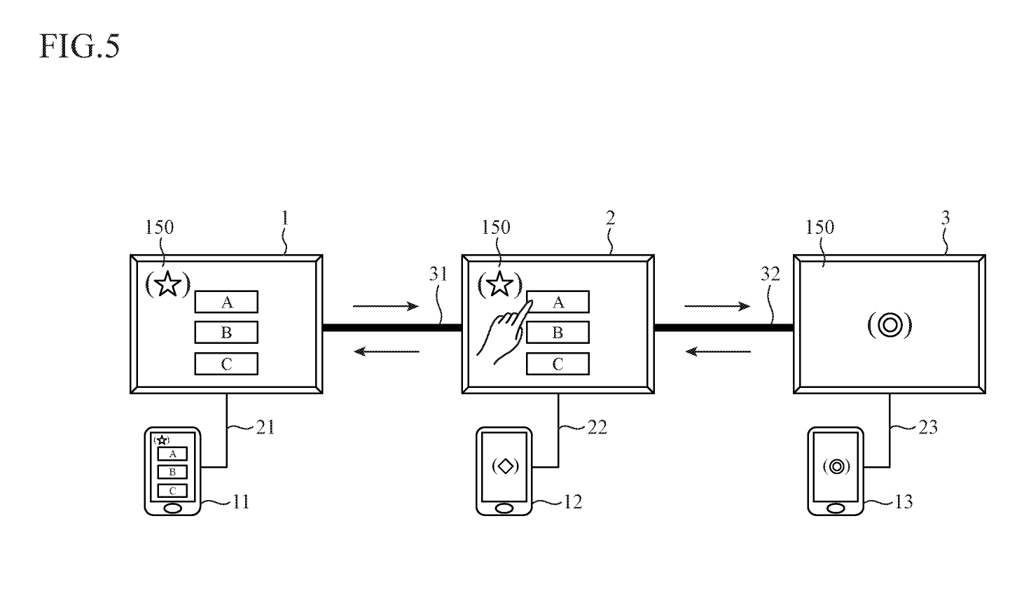

Furthermore, after the screen has been switched, the operation information the user inputs through the operation device 160 of the AV device 2 is superimposed on the communication frame format as the control data and is transferred to the other AV devices 1 and 3. Accordingly, the user can operate the mobile data terminals 11 and 13 through the control units 110 of the destination AV devices 1 and 3. An example of that will be described with reference to FIG. 5.

FIG. 5 shows an example in which the AV device 2 operates the mobile data terminal 11 connected to the AV device 1. In the example shown in FIG. 5, the mobile data terminal 11 operates a music playback application, and displays a menu (star) of musical pieces A-C. The video data of the menu (star) is displayed on the display unit 150 of the AV device 1 and the display unit 150 of the AV device 2.

Here, if the user chooses the musical piece A by operating the operation device 160 of the AV device 2, its operation information is superimposed on the communication frame format as the #2 control data, and is transmitted from the AV device 2 to the AV device 1. The control unit 110 of the AV device 1 transmits the #2 control data received from the AV device 2 to the mobile data terminal 11 via the cable 21. The mobile data terminal 11 reproduces the musical piece A in accordance with the #2 control data received from the AV device 1.

As described above, according to the embodiment 1, it is configured in such a manner that the AV devices 1-3, to which the mobile data terminals 11-13 are connectable through wire, are connected in a multistage fashion through wire, and that each of the AV devices 1-3 comprises: a display unit 150; a communication processing unit 140 to receive a communication signal transmitted across the plurality of AV devices 1-3, and to superimpose on the communication signal the uncompressed video data of the mobile data terminal connected to the self AV device through wire, and to transmit the resultant signal; and the AV integrated processing unit 120 to cause the display unit 150 to display at least one of the uncompressed video data of the mobile data terminal connected to the self AV device through wire and the uncompressed video data which is of the mobile data terminal connected to another one of the AV devices through wire and has been superimposed on the communication signal the communication processing unit 140 receives. Thus, since it connects the AV devices 1-3 through wire and transmits the uncompressed video data, it can suppress the AV processing delay, and handle high-definition images transmitted from another one of the AV devices in real time. In addition, since the AV devices 1-3 are connected with the mobile data terminals 11-13 through wire and handle the uncompressed video data, they can obviate the need for codec. Furthermore, since it comprises one AV control device 100 for one display unit 150, it can reduce the size of the system as compared with a conventional system. This enables increasing the degree of freedom of mounting and wiring the AV devices 1-3.

In addition, according to the embodiment 1, it is configured in such a manner that the communication processing unit 140 recognizes, when the self AV device starts its operation first among the AV devices 1-3 connected in the multistage fashion through wire, that the self AV device is a master, and synchronizes, when another one of the AV devices is a master, in response to the communication signal the master transmits. Accordingly, it can synchronize the AV devices 1-3 connected in a multistage fashion by using the timing extracted from the communication signal of the AV device that becomes the master, thereby being able to stabilize the communication.

In addition, according to the embodiment 1, it is configured in such a manner that each of the AV devices 1-3 comprises the operation device 160 to receive the operation of a user, and that the AV integrated processing unit 120 generates the menu window for enabling the user to choose one of the uncompressed video data of the mobile data terminal connected to the self AV device through wire and the uncompressed video data of the mobile data terminal connected to another one of the AV devices through wire, and causes the display unit 150 to display the menu window, and to display the uncompressed video data corresponding to the choosing operation of the user the operation device 160 receives. Accordingly, the user of the self AV device can easily choose the video data of the mobile data terminal connected to said another one of the AV devices.

Incidentally, although the foregoing embodiment 1 has three AV devices 1-3 connected in a multistage fashion through wire, the number of them is optional. In addition, to add the AV device, it is enough to connect the AV device to the first or the last of the multistage connection, thereby being able to increase or decrease the number easily.

### Embodiment 2

Although the foregoing embodiment 1 is able to output the video/audio data of the mobile data terminal connected to any of the AV device, it will sometimes occur that a user of a mobile data terminal does not want another user to see the video/audio data of his or her own mobile data terminal. In view of this, the embodiment 2 is configured in such a manner that using a menu window of the AV device, a user can enable or disable the video/audio data of the self mobile data terminal to be output on another one of the AV devices.

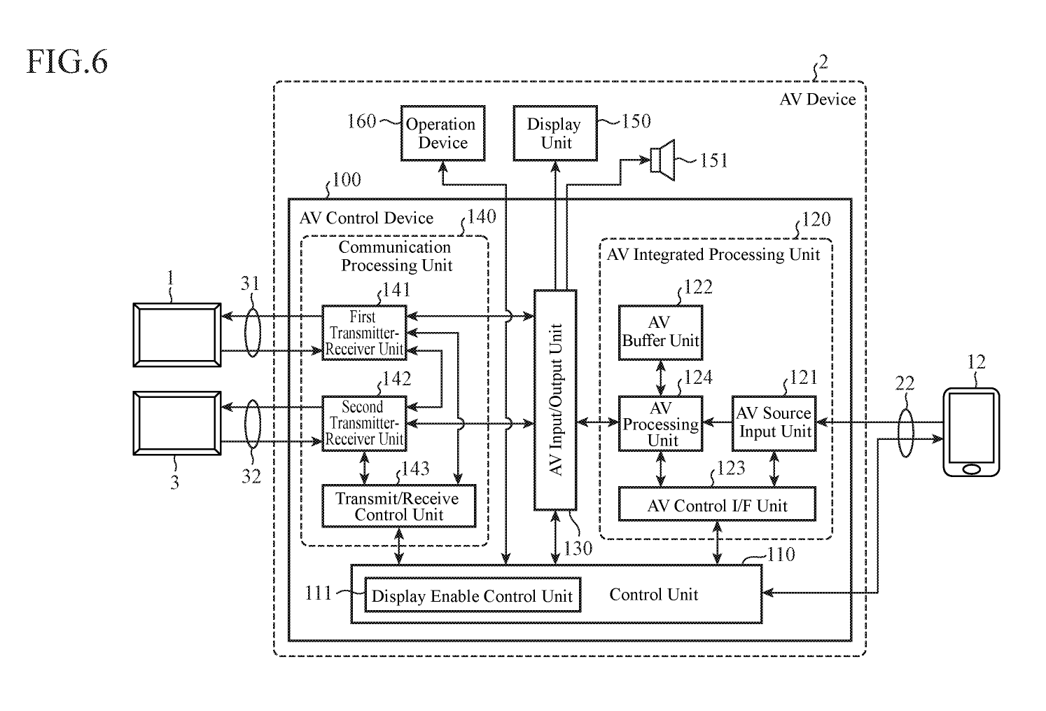

FIG. 6 shows a configuration of the AV device 2 in the vehicle image transmission system of the embodiment 2. Although FIG. 6 shows the AV device 2 as a representative example, the AV devices 1 and 3 have the same configuration. Incidentally, in FIG. 6, the same or corresponding components to those of FIG. 3 are designated by the same reference symbols and their description will be omitted. To the AV device 2 shown in FIG. 6, a display enable control unit 111 is added.

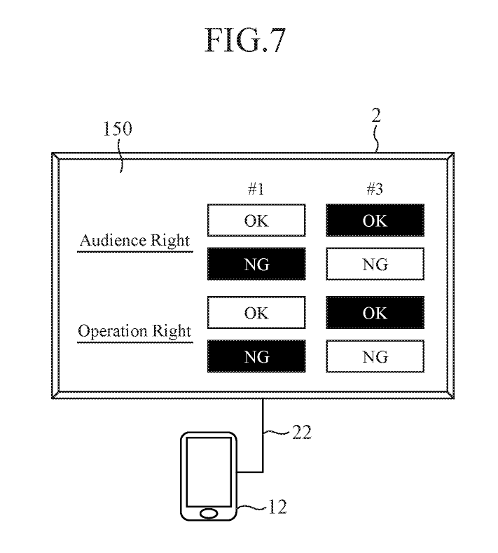

FIG. 7 shows a menu window of the AV device 2 in the vehicle image transmission system of the embodiment 2. Although not shown in FIG. 7, the AV device 2 is connected with the mobile data terminal 12 through wire, and is connected in a multistage fashion with the other AV devices 1 and 3. The AV devices 1 and 3 are connected with the mobile data terminals 11 and 13, respectively.

It is assumed in the menu window displayed on the display unit 150 of the AV device 2 that #1 denotes the AV device 1 and #3 denotes the AV device 3. A user of the mobile data terminal 12 operates the operation device 160 of the AV device 2, sets (viewing right) whether to enable the AV devices land 3 denoted by #1 and #3 to execute a display and audio output of the video/audio data of the mobile data terminal 12 or not, and sets (operation right) whether to enable the AV devices 1 and 3 denoted by #1 and #3 to execute an operation of the mobile data terminal 12 or not. In FIG. 7, the user enables the #1 AV device 1 to view and operate the mobile data terminal 12, but refuses the #3 AV device 3 to view and operate it.

The display enable control unit 111 of the AV device 2 instructs the AV integrated processing unit 120 to generate the menu window as shown in FIG. 7 to cause the display unit 150 to display it. Besides, the display enable control unit 111 receives the setting information about the viewing right and operation right from the operation device 160, and instructs the communication processing unit 140 to superimpose the setting information on the communication header and to transmit its result to the AV devices 1 and 3.

The display enable control unit 111 of each of the AV devices 1-3 instructs the AV input/output unit 130 to choose the video/audio payload in response to the setting information. According to the instruction, the AV input/output unit 130 of the AV device 3 does not transfer the video/audio payload of the AV device 2 received by the communication processing unit 140 to the AV buffer unit 122, but discards it. Accordingly, the video/audio data of the mobile data terminal 12 connected to the AV device 2 is not output from the display unit 150 or speaker 151 of the AV device 3. On the contrary, the AV input/output unit 130 of the AV device 2 does not transfer the control data of the AV device 3 received by the communication processing unit 140 to the control unit 110, but discards it. Accordingly, the mobile data terminal 12 connected to the AV device 2 does not receive the control of the AV device 3.

As described above, according to the embodiment 2, it is configured in such a manner that each of the AV devices 1-3 comprises the display enable control unit 111 for controlling in a manner that the setting information, which controls whether or not to cause another one of the AV devices to display the uncompressed video data of the mobile data terminal connected to the self AV device through wire, is superimposed on the communication signal and is transmitted to said another one of the AV devices, and that whether or not the self AV device is to display the uncompressed video data of the mobile data terminal connected to said another one of the AV devices through wire in response to the setting information superimposed on the communication signal received from said another one of the AV devices. Accordingly, it can prevent other people from viewing the uncompressed video data of the mobile data terminal of the user freely through any other AV devices, and thus enables the user to connect the mobile data terminal to the AV device with a sense of security.

### Embodiment 3

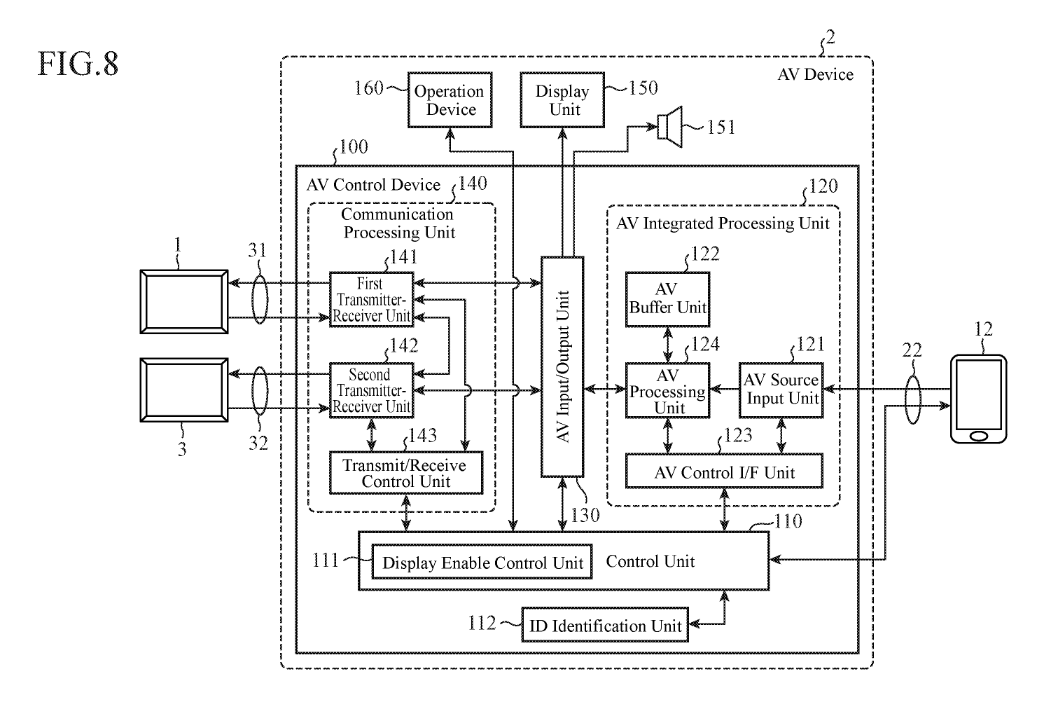

FIG. 8 shows a configuration of the AV device 2 in the vehicle image transmission system of an embodiment 3. Although FIG. 8 shows the AV device 2 as a representative example, the AV devices 1 and 3 have the same configuration. Incidentally, in FIG. 8, the same or corresponding components to those of FIG. 6 are designated by the same reference symbols and their description will be omitted.

To the AV device 2 shown in FIG. 8, an ID identification unit 112 is added. The ID identification unit 112, which stores information indicating the correspondence between ID (identification information) for identifying the mobile data terminals 11-13 and their degrees of priority, recognizes the IDs of mobile data terminals 11-13 and decides the degrees of priority corresponding to the IDs. If a mobile data terminal with a higher degree of priority is connected to any one of the AV devices 1-3, the display enable control unit 111 gives a higher priority to the settings (viewing right and operation right) of the AV device connected with that mobile data terminal over the settings (viewing right and operation right) of the AV device connected to a mobile data terminal with a lower degree of priority. Thus, the AV device with the higher degree of priority can perform remote control of the AV device with the lower degree of priority

As for the ID of the mobile data terminal 12 connected to the AV device 2, the control unit 110 acquires it from the mobile data terminal 12 and outputs it to the ID identification unit 112. In addition, the control unit 110 of the AV device 2 instructs the communication processing unit 140 to superimpose the ID (or the degree of priority) of the mobile data terminal 12 on the communication header, and to transmit it to the AV devices 1 and 3.

As for the IDs (or the degrees of priority) of the mobile data terminals 11 and 13 connected to the other AV devices 1 and 3, the control unit 110 acquires them from the communication headers of the AV devices 1 and 3 received by the communication processing unit 140 of the AV device 2.

For example, when the degree of priority of the mobile data terminal 11 connected to the AV device 1 is highest and the degree of priority of the mobile data terminal 13 connected to the AV device 3 is lowest, even if the AV device 3 sets a refused mode of the display and operation of the video data of the mobile data terminal 13 against the AV device 1, the AV device 1 can display and operate the video data of the mobile data terminal 13.

As described above, according to the embodiment 3, each of the AV devices 1-3 is configured in such a manner that it comprises the ID identification unit 112 and the display enable control unit 111; that the ID identification unit 112 stores the information indicating correspondence between the identification information for identifying the mobile data terminals and their degrees of priority, recognizes the identification information of the mobile data terminal connected to the self AV device through wire and decides the degree of priority corresponding to the identification information, and decides the degree of priority of the mobile data terminal connected to another one of the AV devices through wire in accordance with the identification information superimposed on the communication signal received from said another one of the AV devices; and that the display enable control unit 111 gives priority to the setting information of said another one of the AV devices when deciding from the decision result of the ID identification unit 112 that the degree of priority of the mobile data terminal connected to said another one of the AV devices through wire is higher than the degree of priority of the mobile data terminal connected to the self AV device through wire. Accordingly, it can perform the remote control of the mobile data terminal that refuses the display. In addition, placing a higher priority on the mobile data terminal of a manager enables the manager to monitor and control the whole system.

Incidentally, although the foregoing embodiment 3 has a configuration of controlling the viewing right and operation right in accordance with the degrees of priority of the mobile data terminals 11-13, it is not limited to the configuration, but a configuration is also possible which assigns degrees of priority to the AV devices 1-3, and controls the viewing right and operation right in accordance with the degrees of priority. For example, the AV device mounted on the driver' s seat is provided with the highest degree of priority so that it can carry out remote control to the mobile data terminals connected to the AV devices mounted on the other seat through wire.

Incidentally, it is to be understood in addition to the foregoing that a free combination of the individual embodiments, variations of any components of the individual embodiments or removal of any components of the individual embodiments is possible within the scope of the present invention.

### INDUSTRIAL APPLICABILITY

A vehicle image transmission system in accordance with the present invention is configured in such a manner as to transmit uncompressed video data between a plurality of AV devices connected in a multistage fashion through wire. Accordingly, it is suitable for an image transmission system to be mounted in a vehicle like a car.

### DESCRIPTION OF REFERENCE SYMBOLS

1-3 AV device; 11-13 mobile data terminal; 21-23, 31, 32 cable; 100 AV control device; 110 control unit; 111 display enable control unit; 112 ID identification unit; 120 AV integrated processing unit; 121 AV source input unit; 122 AV buffer unit; 123 AV control I/F unit; 124 AV processing unit; 130 AV input/output unit; 140 communication processing unit; 141 first transmitter-receiver unit; 142 second transmitter-receiver unit; 143 transmit/receive control unit; 150 display unit; 151 speaker; 160 operation device.

1. A vehicle image transmission system including a plurality of AV devices which are connectable with mobile data terminals through wire, and are connected in a multistage fashion through wire, each of the AV devices comprising:
a display;
a communication processor to receive a communication signal transmitted across the plurality of AV devices connected in the multistage fashion through wire, and to superimpose, on the communication signal, uncompressed video data of the mobile data terminal connected to the self AV device through wire, and to transmit a resultant signal;
an AV integrated processor to cause the display to display at least one of the uncompressed video data of the mobile data terminal connected to the self AV device through wire and uncompressed video data that is of the mobile data terminal connected to another one of the AV devices through wire and that has been superimposed on the communication signal the communication processor receives; and
a display enable controller to perform control in a manner that setting information, which controls whether to cause said another one of the AV devices to display the uncompressed video data of the mobile data terminal connected to the self AV device through wire, is superimposed on the communication signal and transmitted to said another one of the AV devices, the display enable controller controlling whether to display the uncompressed video data of the mobile data terminal connected to said another one of the AV devices through wire, on the self AV device, based on the setting information superimposed on the communication signal received from said another one of the AV devices.

2. The vehicle image transmission system according to claim 1, wherein
the communication processor recognizes, when the self AV device starts operation thereof first among the plurality of AV devices connected in the multistage fashion through wire, that the self AV device is a master, whereas when another one of the AV devices is a master, the communication processor synchronizes in response to the communication signal transmitted by the master.

3. The vehicle image transmission system according to claim 2, wherein each of the AV devices comprises:
an operation device to receive an operation of a user, and wherein
the AV integrated processor generates a menu window for enabling the user to select the uncompressed video data to be displayed on the display from among the uncompressed video data of the mobile data terminal connected to the self AV device through wire and the uncompressed video data of the mobile data terminal connected to another one of the AV devices through wire, and causes the display to display the menu window, and to display the uncompressed video data corresponding a selecting operation of the user the operation device receives.

4. (canceled)

5. The vehicle image transmission system according to claim 1, wherein each of the AV devices comprises:
an ID identification unit to store information indicating correspondence between identification information for identifying the mobile data terminals and degrees of priority, to recognize the identification information of the mobile data terminal connected to the self AV device through wire and to decide the degree of priority corresponding to the identification information, and to decide the degree of priority of the mobile data terminal connected to said another one of the AV devices through wire in accordance with the identification information superimposed on the communication signal received from said another one of the AV devices, and wherein
the display enable controller gives priority to the setting information of said another one of the AV devices when deciding, based on a decision result of the ID identification unit, that the degree of priority of the mobile data terminal connected to said another one of the AV devices through wire is higher than the degree of priority of the mobile data terminal connected to the self AV device through wire.
